(19) United States
(12) Patent Application Publication
(10) Pub. No.: US 2017/0189946 A1
(43) Pub. Date: Jul. 6, 2017

(54) SCRAPING TOOL

(71) Applicant: Donald A. Beardsley, Auburn, NY (US)

(72) Inventor: Donald A. Beardsley, Auburn, NY (US)

(73) Assignee: Donald A. Beardsley, Auburn, NY (US)

(21) Appl. No.: 15/395,414

(22) Filed: Dec. 30, 2016

Related U.S. Application Data
(60) Provisional application No. 62/272,949, filed on Dec. 30, 2015.

(51) Int. Cl. B08B 9/087

(52) U.S. Cl. CPC B08B 9/087

(57) ABSTRACT

A scraping tool having a handle, an arcuately-shaped blade configured to fit a curved surface of the inside of a container, a neck configured to couple the handle to the blade, and a lip extending outward from the front surface at an angle.

### CROSS-REFERENCE TO RELATED APPLICATION

Pursuant to relevant sections of 35 U.S.C. §119 and 37 C.F.R. §1.53, this application is a non-provisional of, and claims the benefit and priority of, U.S. Provisional Patent Application No. 62/272,949, filed on Dec. 30, 2015. The entire contents of this application is hereby incorporated by reference.

### TECHNICAL FIELD

This application is directed generally to the field of tools and more specifically to a tool which can be used to aid in scraping, mixing, and combining various materials, such as those that would be used in the construction industry.

### BACKGROUND OF THE INVENTION

The construction industry relies on many different kinds of building materials. Many of these materials, such as cement, joint compound, flooring adhesive, and numerous others, are prepared by mixing two or more ingredients together. When large amounts of such materials are required, the mixing process is performed off-site at a manufacturing facility or en route to the building site by a specially outfitted vehicle such as a concrete mixing truck.

However, when relatively small amounts of such materials are required, the mixing takes place on site. The components are loaded into a container or bucket and mixed with a hand-held mixer. In many instances, one or more of the components are prepackaged in a container having a volume of between 1.5 and 6 gallons such that mixing can take place in the container itself During the mixing, a worker will need to use a trowel to scrape unmixed material from the sides of the bucket in-between passes with the hand mixer in order to incorporate this unmixed material into the mixture. This process is time consuming, back-breaking, and inefficient because it fails to incorporate unmixed material which collects between the bottom surface of the bucket and the sides of the bucket. Moreover, these building materials can be thick, heavy mixtures that are difficult to manipulate using a hand trowel or other hand tool. In addition, many of these may include resins which increase the stickiness of the mixture and make the mixture hard to remove from the trowel or other hand tool during clean-up.

The foregoing background describes some, but not necessarily all, of the problems, disadvantages and short comings related to scraping tools.

### BRIEF DESCRIPTION OF THE INVENTION

In an embodiment, a scraper is provided having a handle which includes a grip portion, and an arcuately-shaped blade having a front surface and a rear surface. The rear surface of the blade is configured to fit a curved interior surface of a side of a container.

The scraper further includes a neck configured to couple the handle to the blade and a lip extending outward from the front surface at an angle.

In another embodiment, a scraping tool includes a handle and an arcuately-shaped blade having a front surface and a rear surface. The rear surface of the blade is configured to fit a curved interior surface of a side of a container. The scraping tool further includes a neck configured to couple the handle to the blade and a lip extending outward from the front surface at an angle, wherein the angle is greater than 90°.

Some advantages that may be realized in the practice of some disclosed embodiments of the scraper are more efficient/complete mixing of building materials, less strain on one's back during use, increased durability, and easier clean-up.

This brief description of the invention is intended only to provide a brief overview of subject matter disclosed herein according to one or more illustrative embodiments, and does not serve as a guide to define or limit the scope of the invention. This brief description is provided to introduce an illustrative selection of concepts in a simplified form that are further described below in the detailed description. This brief description is not intended to identify key features or essential features of the invention, nor is it intended to be used as an aid in determining the scope of the invention.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 illustrates a perspective view of an embodiment of the scraping tool;

FIG. 2 illustrates a front plan view of an embodiment of the scraping tool;

FIG. 3 illustrates a front plan view of an embodiment of the handle of the scraping tool;

FIG. 4 illustrates a perspective view an embodiment of the handle and the neck of the scraping tool;

FIG. 5 illustrates a front plan view of an embodiment of the blade engagement portion of the neck of the scraping tool;

FIG. 6 illustrates a front plan view of an embodiment of a portion of the neck and the blade of the scraping tool;

FIG. 7 illustrates a front plan view of an embodiment of the blade of the scraping tool;

FIG. 8 illustrates a rear perspective view of an embodiment of the blade of the scraping tool;

FIG. 9 illustrates a right side plan view of an embodiment of the blade of the scraping tool;

FIG. 10 illustrates a top plan view of an embodiment of the blade of the scraping tool;

FIG. 11 illustrates front perspective view of an embodiment of the scraping tool and a container; and

FIG. 12 illustrates a cross-section of an embodiment of the scraping tool and container.

### DETAILED DESCRIPTION OF THE INVENTION

The following description relates to a scraping tool or scraper. It will be readily apparent that other variations and modifications are possible. In addition, certain terms are used throughout to provide a frame of reference in regard to the accompanying drawings. These terms, which may include “front”, “rear”, “distal”, “proximal”, “inner”, “outer”, “interior”, “exterior” and the like are not intended to be limiting, unless so specifically indicated.

The herein described scraping tool or scraper can be used to assist in the mixing of small batches of mixed materials, such as various types of building materials. Generally, the scraper comprises a handle, a neck and a curved blade. In an embodiment, the scraper is configured to scrape unmixed building material from the sides of a container or bucket as well as from the bottom of a container or bucket while the user stands upright. As described, the scraper is made from galvanized steel and may be partially coated with Teflon® or other non-stick material.

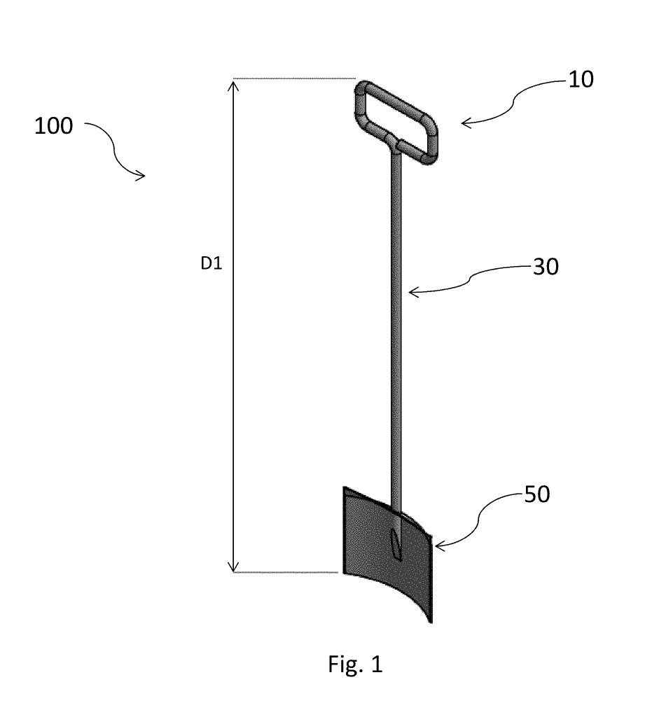

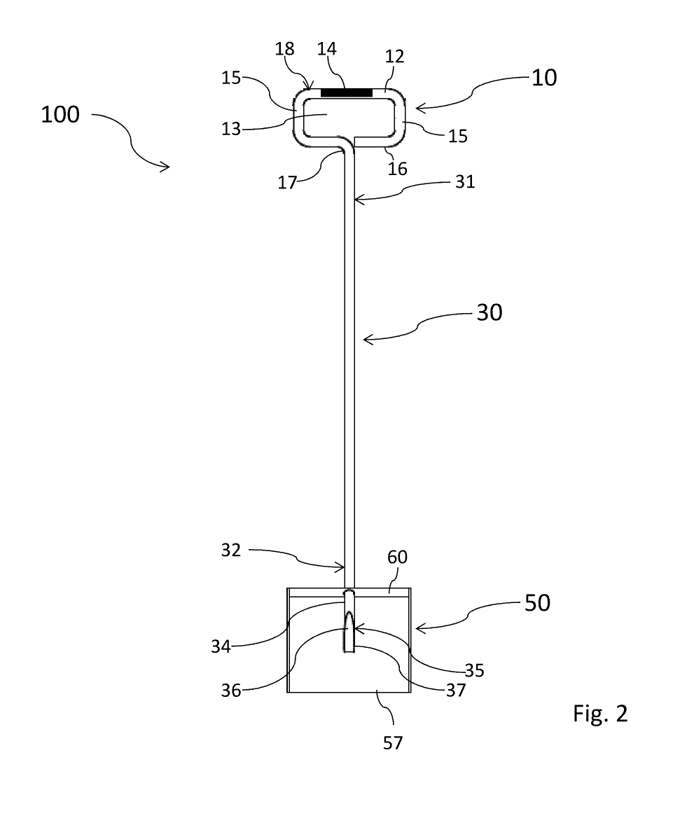

Referring to FIGS. 1-2, in an embodiment, the scraping tool or scraper 100 generally comprises a handle 10, a neck 30, and a blade 50. As shown in FIG. 1, the scraper 100 has a length D1 from the top of the handle 10 to the bottom of the blade 50 to enable the user to operate it while standing upright. It can be appreciated that D1 may be any dimension suitable for carrying out the functions of the scraper 100 while allowing a user to operate it from a standing position.

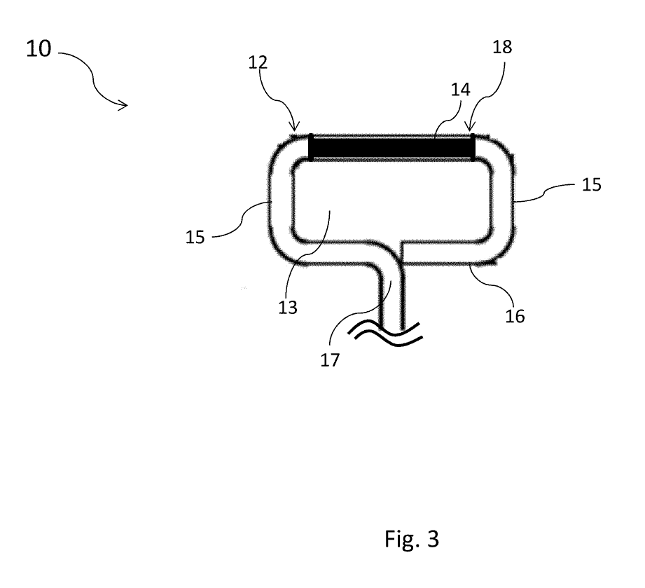

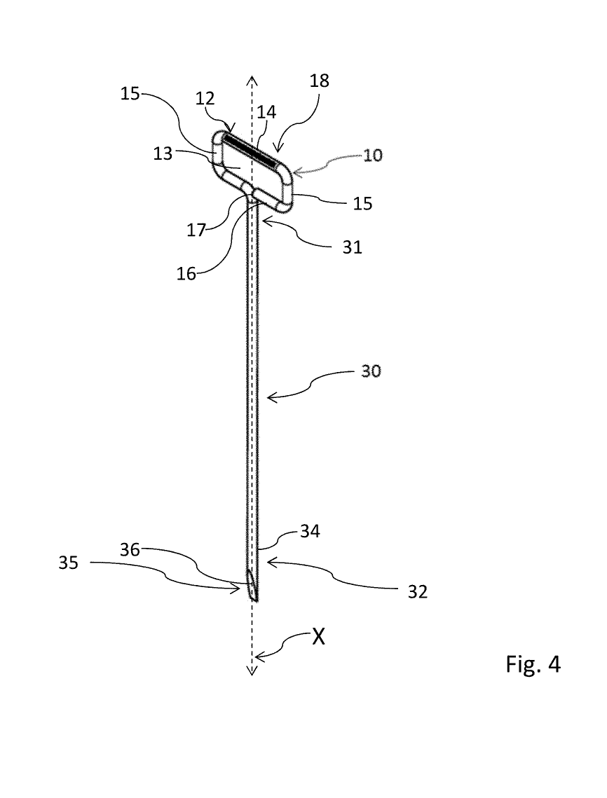

Referring to the embodiments illustrated in FIGS. 2-4, the handle 10 comprises a grip portion 12, two grip supports 15, a false junction 16, and a neck coupling portion 17. As shown, the grip portion 12 includes a gripping surface 18 and a textured portion 14 to assist the user in grasping the scraper 100. The textured portion 14 may be a separate component that is attached to the gripping surface 18 by an adhesive, a mechanical fastener, or any other appropriate means to attach the textured portion 14 to the gripping surface 18. In another embodiment, the textured portion 14 and the gripping surface 18 of the grip portion 12 may be a single unitary structure. The neck coupling portion 17 couples the handle 10 to the neck 30 (FIGS. 2 and 4).

A handle opening 13 is defined by the grip portion 12, the grip supports 15, the false junction 16, and the neck coupling portion 17. The handle opening 13 allows for a 360 degree gripping surface 18 to be exposed for the user to grasp. The entire gripping surface 18 may include a textured surface 1, however in other embodiments, only a portion of the gripping surface 18 may include a textured surface. In an alternate embodiment, the handle 10 may not include a handle opening 13. In another embodiment, the handle 10 may not include grip supports 15, or a false junction 16. In one embodiment, the handle 10 does not include a handle opening 13 and instead is directly coupled to the grip portion 12. As shown, the handle 10 is formed from a single piece of material such as galvanized steel and is a single unitary component. However, other durable, rigid materials capable of withstanding the wear and tear of construction work may be used such as carbon steel, or a thick piece of polyvinyl chloride. Having a single unitary handle 10 greatly increases the strength and durability of the scraper 100. However, in another embodiment, the handle 10 components may be separate and attached to each other using a series of welds, bolts, or other suitable fasteners or fastening methods.

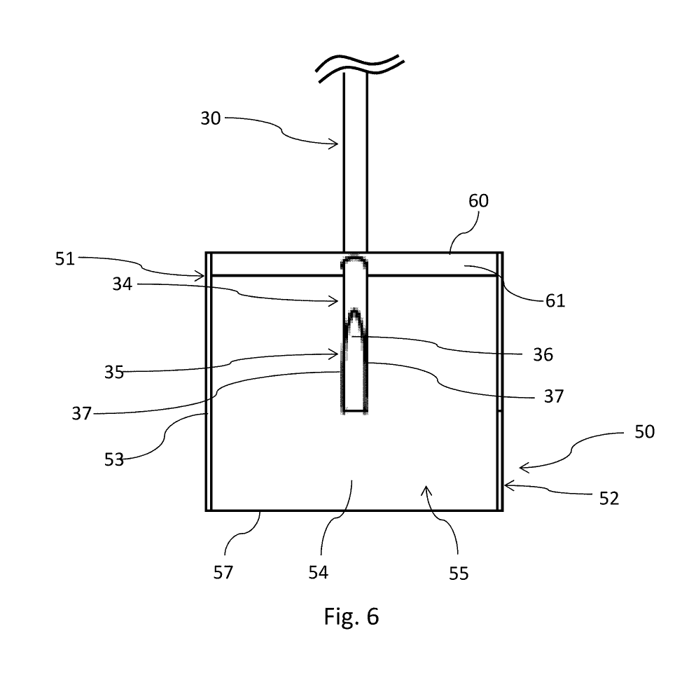

Referring to the embodiments shown in FIGS. 4-6, the neck 30 of the scraper 100 includes a first end 31 and a second end 32. The first end 31 of the neck 30 is coupled to the neck coupling portion 17 (FIG. 4) of the handle 10 and the second end 32 of the neck 30 is coupled to the blade 50 (FIG. 6). As shown in FIG. 4, the neck 30 and the handle 10 are formed from a single piece of material and are a single unitary component. As shown, the neck 30 is substantially cylindrical such that a cross-section of the neck 30 is substantially circular. However, in other embodiments, the cross section of the neck 30 may be triangular, or any other polygonal shape that is not substantially circular. Referring to FIG. 4, the neck 30 extends along a single axis X from the first end 31 of the neck 30 to the second end 32 of the neck 30, however in other embodiments, the neck 30 may not extend along a single axis X. As shown, the handle 10 and the neck 30 are substantially coplanar, however in other embodiments one or more portions of the neck 30 can extend along a different plane.

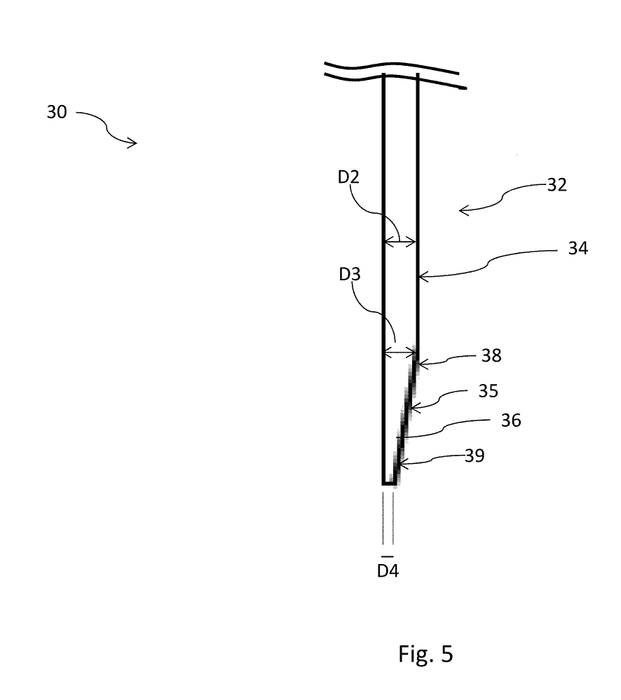

Referring to FIGS. 4-6, the second end 32 of the neck 30 includes a blade engagement portion 34. As shown, the blade engagement portion 34 comprises a taper 35 with a taper surface 36 (FIG. 5-6) As shown, the blade engagement portion 34 is coupled to the blade 50 by one or more welding joints 37 (FIG. 6). The taper 35 decreases the profile of the neck 30 while also increasing the surface area of the welding joints 37 and thereby increasing the strength of the welding joints 37. Referring to the embodiment of FIG. 5, the proximal end 38 of the taper 35 has a diameter D3, which is substantially equal to the diameter D2 of the of the neck 30. The distal end 39 of the taper 35 has a diameter D4 which is smaller than D3. The pitch of the taper surface 36 (FIG. 6) follows the slant of the taper 35 and aids in preventing the buildup of building material between the blade 50 and the blade engagement portion 34.

As shown in FIG. 4, the neck 30 and the handle 10 are formed from a single piece of material, such as galvanized steel. However, other durable, rigid materials capable of withstanding the wear and tear of construction work may be used, such as carbon steel or polymers. In an embodiment, the handle 10 and neck 30 are formed from a solid galvanized steel rod.

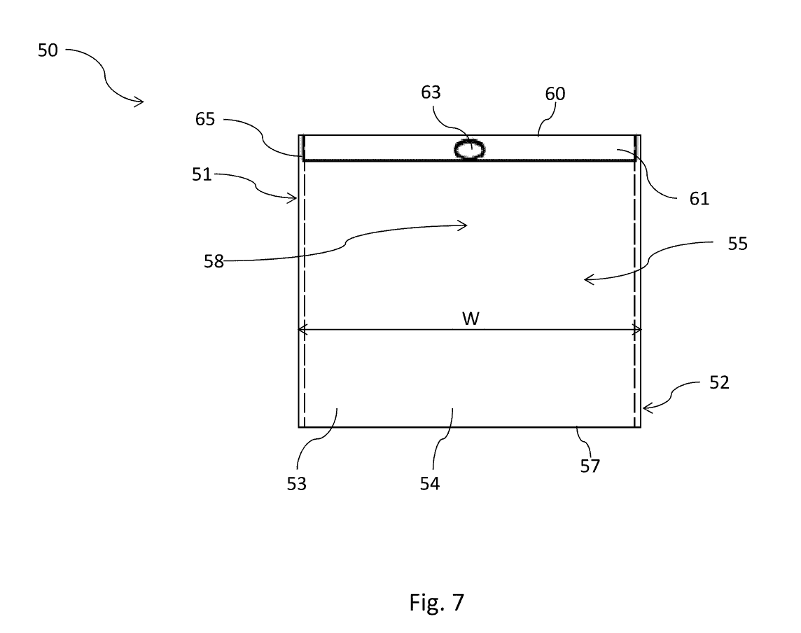

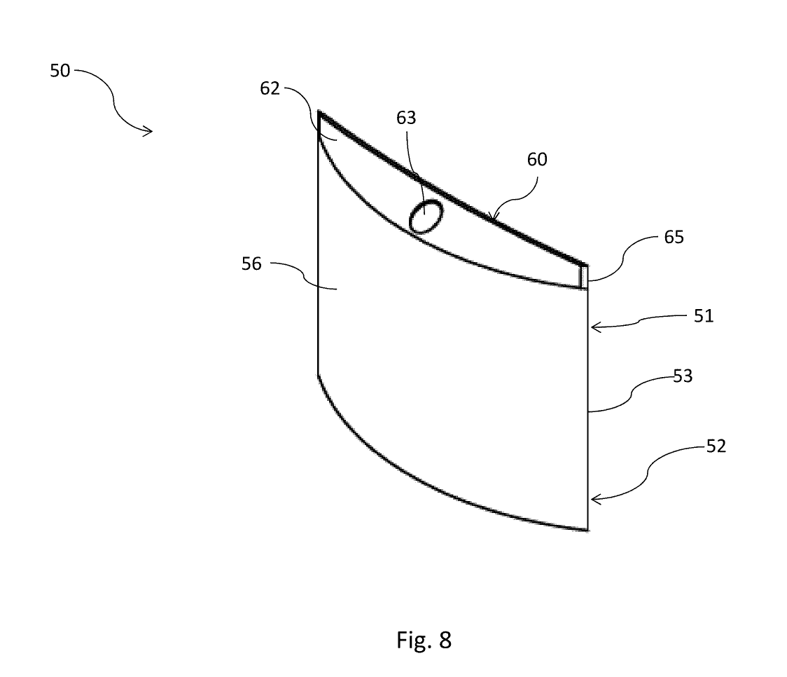

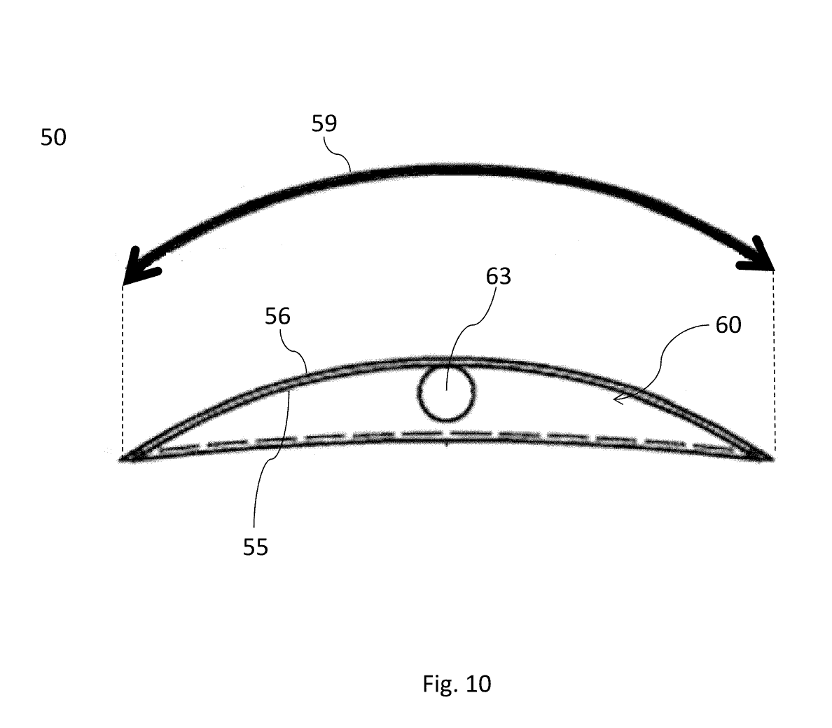

Referring to FIGS. 6-10, the blade 50 includes a top end 51, a bottom end 52, blade sides 53, as well as a front blade surface 55 and a rear blade surface 56 (FIG. 8). The top end 51 of the blade 50 includes a lip 60 and the bottom end of the blade 50 includes a blade edge 57. As shown in FIG. 7, the front blade surface 55 includes a blade center 54 and a weld surface 58 which receives the one or more welding joints 37 (FIG. 6) used to couple the blade engagement portion 34 of the neck 30 to the blade 50. Referring to FIGS. 8 and 10, the front blade surface 55 and the rear blade surface 56 are arcuately-shaped across the width W (FIG. 7) of the blade 50.

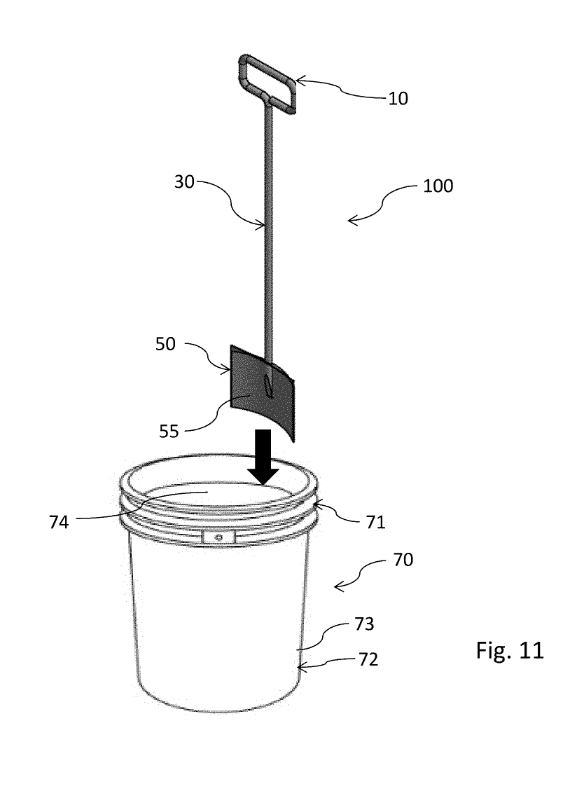

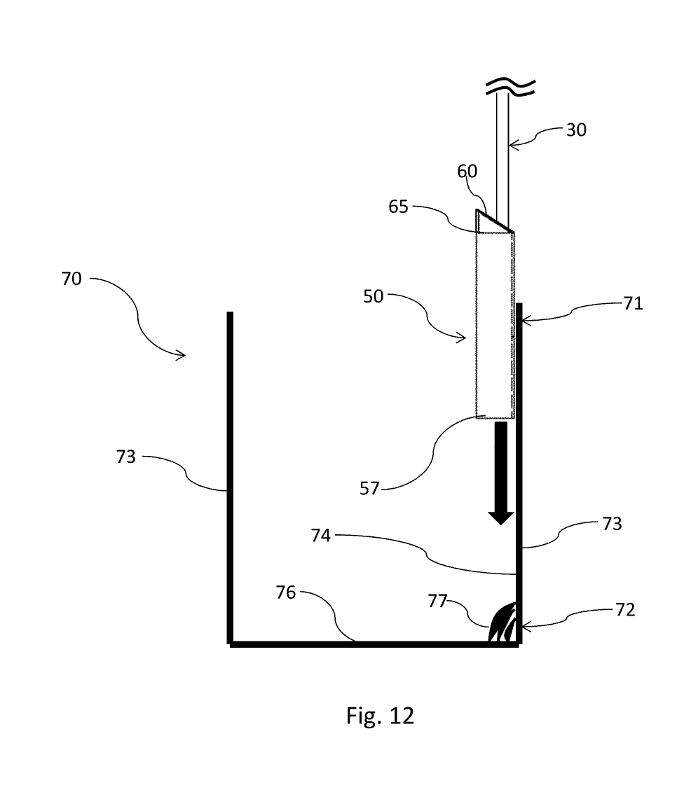

As shown in FIG. 10, the arc 59 of the front and rear blade surfaces 55, 56 is congruent to the curvature of the inside of a container or bucket with a volume from 1.5 to 6 gallons, which is commonly used to package building materials and also to mix these materials. In the embodiments of FIG. 10, the arc 59 of the front blade surface 55 is equal to the arc of the rear blade surface 56. As shown, in FIG. 10, the length of the arc 59 is about one-fifth of the total circumference of the container or bucket 70 (FIG. 11-12) such that the user can effectively scrape the interior side surface 74 (FIG. 12) of the entire bucket 70 (FIG. 12) in five vertical passes. In other embodiments, the length of the arc 59 may not be about one-fifth of the total circumference of the mixing bucket 70 (FIG. 11-12). The blade edge 57 (FIG. 7) is configured to scrape material that, not only clings to the sides of the bucket 70 (FIG. 11), but also trapped material 77 (FIG. 12) deposited between the interior bottom surface 76 (FIG. 12) of the mixing bucket 70 (FIG. 11-12) and interior side surface 74 (FIG. 12).

As described, the blade 50 is made of a stamped piece of galvanized steel, however any rigid, durable metal or high strength plastic would be suitable for use. In an embodiment, the scraper 100 is coated with a protective paint that resists rust, degradation by the environment, and daily wear and tear. In another embodiment, the blade 50 and a portion of the neck 30 are coated with Teflon® or another non-stick coating to prevent material from sticking to and/or permanently adhering to said parts of the scraper 100.

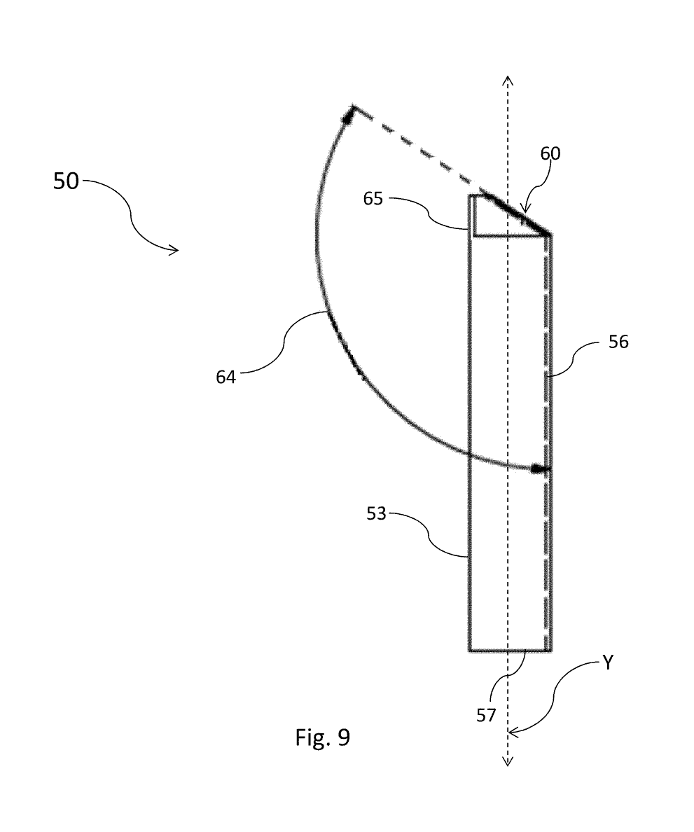

Referring to FIGS. 6-12, a lip 60 extends from the top end 51 of the blade 50. In an embodiment, the lip 60 and the top end 51 of the blade 50 are a single unitary component however, in another embodiment, the lip 60 may be attached to the blade 50 by one or more welds, bolts, or any other suitable fastening means. The lip 60 includes an angled lip surface 61 (FIG. 7) and a rearward facing lip surface 62 (FIG. 8). Referring to FIG. 9, the angled lip surface 61 projects from the top end 51 of the blade 50 at an angle relative to the axis Y of the blade 50 such that the lip 60 and the front blade surface 55 are not coplanar. As shown in FIG. 9, the angle 64 is approximately 123° relative to the axis Y of the blade 50, however in other embodiments, the angularity may vary. In a further embodiment, the angle 64 is greater than 90° relative to the axis Y of the blade 50. The angled lip surface 61 and the rearward facing lip surface 62 define an orifice 63 (FIGS. 7-8 and 10) which traverses the lip 60 and is configured to engage a portion of the neck 30 (FIG. 6). In an embodiment, the sides of the lip 60 terminate at a lip end 65 (FIGS. 8-9). As shown in FIG. 8, the lip end 65 does not protrude outward from the front blade surface 55 at an angle 64 (FIG. 9).

Referring to FIGS. 11-12, a bucket 70 with a volume between 1.5 gallons and 6 gallons comprises a top end 71, a bottom end 72 with an interior bottom surface 76 (FIG. 12) and bucket sides 73. As shown in FIG. 12, the bucket sides 73 have an interior side surface 74. The interior side surfaces 74 and the interior bottom surface 76 define a mixing chamber 75. The interior side surface 74 and the interior bottom surface 76 of the bucket 70 are substantially smooth. The interior side surface 74 is curved and is substantially a circle. The bucket 70 may be made of high density polyethylene or any other suitable rigid, durable, waterproof material.

In an embodiment, the scraper 100 is approximately 30 inches tall (FIG. 1) so the user may operate it without bending over. However, other embodiments of the scraper 100 may be of a different height which still allows the user to operate it while standing upright.

Referring to FIGS. 11-12, the user grasps the handle 10 of the scraper 100 at the gripping surface 18 and advances the scraper 100 down the interior side surface of the bucket 70 in a direction from the top end 71 of the bucket 70 to the bottom end 72 of the bucket 70 as indicated by the arrows. The arc 59 (FIG. 10) of the rear blade surface 56 allows the entire rear blade surface 56 to contact and ride along the interior side surface 74 of the bucket side 73. As shown, the identical arc 59 (FIG. 10) of the front blade surface 55 of the blade 50 allows the blade edge 57 to contact and ride along the interior side surface 74 of the bucket 70 and remove mixed and unmixed material stuck to the interior side surface 74. In addition, advancing the scraper 100 along the interior side surface 74 of the bucket side 73 from the top end 71 to the bottom end 72 causes the mixed and unmixed material to ride up the angled lip surface 61 of the lip 60 and be directed towards the center of the mixing chamber 75 where it may be incorporated into the general mixture during the next round of mixing. Referring to FIG. 12, once the blade edge 57 of the scraper 100 reaches the bottom end 72 of the interior side surface 74 of the bucket side 73, the user moves the blade 50 away from the interior side surface 74 or the bucket 70 and towards the center of the mixing chamber 75. This action breaks up the unmixed material trapped 77 (FIG. 12) between the interior side surface 74 of the bucket side 73 and the interior bottom surface 76.

Additional embodiments include any one of the embodiments described above and described in any and all exhibits and other materials submitted herewith, where one or more of its components, functionalities or structures is interchanged with, replaced by or augmented by one or more of the components, functionalities or structures of a different embodiment described above.

It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A scraper comprising:
a handle, the handle including a grip portion;
an arcuately-shaped blade extending along an axis and having a front surface and a rear surface, the rear surface is configured to fit a curved interior surface of a side of a container;
a neck configured to couple the handle to the arcuately-shaped blade; and
a lip extending outward from the front surface at an angle relative to the axis.

2. The scraper of claim 1, wherein the lip includes an orifice configured to accept a portion of the neck.

3. The scraper of claim 1, wherein the angle relative to the axis is greater than 90°.

4. The scraper of claim 1, wherein the handle and the neck are a single unitary component.

5. The scraper of claim 1, wherein the arcuately-shaped blade and a portion of the neck are coated with a non-stick material.

6. The scraper of claim 1, wherein the handle defines a handle opening configured to expose a gripping surface.

7. The scraper of claim 6, wherein the gripping surface has a textured surface, the textured surface and the gripping surface comprising a single unitary component.

8. A scraping tool comprising:
a handle;
an arcuately-shaped blade extending along an axis and having a front surface and a rear surface, the rear surface is configured to fit a curved interior surface of a side of a container;
a neck configured to couple the handle to the arcuately-shaped blade; and
a lip extending outward from the front surface at an angle, wherein the angle is greater than 90° relative to the axis.

9. The scraping tool of claim 8, wherein the lip includes an orifice configured to accept a portion of the neck.

10. The scraping tool of claim 8, wherein the arcuately-shaped blade and a portion of the neck are coated with a non-stick material.

11. The scraping tool of claim 8, wherein the handle defines a handle opening configured to expose a gripping surface.

12. The scraping tool of claim 11, wherein the gripping surface includes a textured surface.

13. The scraping tool of claim 12, wherein the gripping surface and the textured surface are a single unitary component.
